(19) United States
(12) Patent Application Publication
(10) Pub. No.: US 2022/0410665 A1
(43) Pub. Date: Dec. 29, 2022

(54) COOLANT MANAGEMENT FOR A REHEATING PROCESS FOR OPERATING A COOLING SYSTEM FOR A MOTOR VEHICLE, COOLING SYSTEM, AND MOTOR VEHICLE HAVING SUCH A COOLING SYSTEM

(71) Applicant: AUDI AG, Ingolstadt (DE)

(72) Inventors: Dirk SCHROEDER, Manching (DE); Christian REBINGER, München (DE); Marco WILL, Ingolstadt (DE); Simon BOGNER, Freystadt (DE)

(73) Assignee: AUDI AG, Ingolstadt (DE)

(21) Appl. No.: 17/778,163

(22) PCT Filed: Sep. 28, 2020
(86) PCT No.: PCT/EP2020/077053

§ 371 Date: May 19, 2022

(30) Foreign Application Priority Data
Dec. 19, 2019 (DE) 10 2019 135 056.5

(51) Int. Cl. B60H 1/32; B60H 1/00

(52) U.S. Cl. CPC B60H 1/3207; B60H 1/00821; B60H 1/00835; B60H 1/00207; B60H 1/00885; B60H 2001/00928; B60H 2001/00242; B60H 1/00921

(57) ABSTRACT

A reheating process for operating a cooling system having a heat pump function for a motor vehicle. The reheating process includes steps of determining a heat differential value by comparing a heat emission actual value at the heating register to a heat emission target value, and adjusting at least one operating setting of the cooling system, so that the power consumption in the cooling system is increased if the heat differential value is greater than 0 and less than a heat differential threshold value.

### FIELD

The invention relates to a reheating process (RHIII) for operating a cooling system for motor vehicle, a cooling system, and a motor vehicle having such a cooling system. In particular, the reheating process comprises steps which are configured to optimize the coolant management in the context of specific operating conditions of the cooling system.

### BACKGROUND

A cooling system having heat pump function typically comprises a coolant compressor, which is connectable or connected to a primary line and a secondary line; an external heat exchanger, which is arranged in the primary line; an evaporator, which is arranged in the primary line; a heating register, which is arranged in the secondary line, at least one movable temperature valve, which is arranged before or after the heating register with respect to a supply air flow direction; and at least one reheating expansion valve, which is arranged between the heating register and the external heat exchanger in the secondary line.

Such a cooling system having heat pump function is described, for example, in DE 10 2018 213 232.1, which was not yet published at the time of the filing of the present application.

Further background information on cooling systems or heat pumps can be found, for example, in documents DE 10 2015 210 414 A1, DE 10 2011 118 162 A1, and DE 10 2015 002 166 A1.

In a reheating process, which is also referred to in technical jargon as reheat, reheat mode, and reheat process, in the climate control of a vehicle interior, the air cooled and dehumidified by the evaporator is brought to a desired air outlet temperature by at least partial heating by means of the heating register.

The heating register is a heat source in which heat stored in the coolant is emitted to another medium, such as air, water, water-glycol mixture, and the like. The heating register can be designed as a heating condenser or heating gas cooler if (ambient) air flows through it directly as cabin supply air, which absorbs the emitted heat. The heating register can be designed as a fluid heat exchanger if a fluid other than (ambient air), for example, water, water-glycol mixture, or the like flows through or around it, wherein the heat stored in the coolant is emitted to the fluid. In the design as a fluid heat exchanger, a further heat transfer takes place from the heated fluid to the (ambient) air. Indirect heating of (ambient) air as a cabin supply air flow is thus carried out by a fluid heat exchanger.

In a reheating or reheat mode, the desired power for heating a vehicle interior can be set via a regulation of the reheating expansion valve. One possible parameter for the heat emission or the heating power can be an air outlet temperature of conditioned air into the vehicle interior.

If an excess of heat or heating power is ascertained, wherein, for example, the actual air outlet temperature is greater than a target air outlet temperature, the reheating expansion valve can in particular be opened step-by-step. The high pressure sinks at the heating register in this way and an (increasing) moderate or intermediate pressure results at the external heat exchanger. The condensation temperature accordingly rises and the temperature difference in relation to the surroundings increases, so that more heat is emitted to the surroundings via the external heat exchanger.

If a deficit of heat or heating power is ascertained, wherein, for example, the actual air outlet temperature is less than a target air outlet temperature, the reheating expansion valve can in particular be closed step-by-step. The high pressure rises at the heating register in this way and the moderate or intermediate pressure sinks at the external heat exchanger. The condensation temperature sinks accordingly and the temperature difference in relation to the surroundings decreases, so that less heat is emitted to the surroundings via the external heat exchanger.

It has been shown that the following situation can result in the cooling system in the event of small excesses of heat or heating power. The coolant is present nearly completely in liquid form in the external heat exchanger. A coolant deficiency can thus occur on the low-pressure side of the cooling system, thus downstream of the evaporator, which results in overheated exit of coolant from the evaporator.

Such overheating can have an effect, for example, on the air-side temperature at the evaporator, so that the interior comfort in the vehicle is negatively influenced in this way. In other words, large temperature spreads result in the exhaust air flow of the evaporator, which results in the comfort losses due to temperature inhomogeneity but also worse dehumidification performance.

Furthermore, depending on the design of the cooling system, oil can be deposited in the coolant accumulator. Due to the absence of or a strong reduction in a liquid phase of coolant in the coolant accumulator, the oil can remain back in the coolant accumulator and is no longer supplied to the evaporator, which can result in lubrication problems at the evaporator.

### SUMMARY

The underlying object of the invention is considered to be that of specifying a reheating process in which the above disadvantages can be avoided.

A reheating process for operating a cooling system having heat pump function for a motor vehicle is thus proposed, wherein the cooling system comprises:

a coolant compressor, which is connectable or connected to a primary line and a secondary line;

an external heat exchanger, which is arranged in the primary line; an evaporator, which is arranged in the primary line; a heating register, which is arranged in the secondary line;

at least one reheating expansion valve, which is arranged between the heating register and the external heat exchanger in the secondary line. The reheating process comprises the following steps:

determining a heat differential value by comparing a heat emission actual value at the heating register to a heat emission target value, adapting at least one operating setting of the cooling system so that the load consumption in the cooling system is increased when the heat differential value is greater than 0 and is less than a heat differential threshold value.

The heat emission actual value and the heat emission target value can be established, for example, on the basis of measured or predetermined air outlet temperature of conditioned supply air into the vehicle interior. The heat emission actual value and heat emission target value can also become or be determined, however, on the basis of other measurable variables or parameters of the cooling system. In particular, they can become or be determined from a combination of available cooling system parameters and climate control parameters.

The heat differential threshold value can be established here so that it represents a low excess of heat or heating power. If one presumes, for example, that the heat differential value is calculated starting from an actual air outlet temperature and a target air outlet temperature, the heat differential threshold value can be set, for example, at 5 or less, but greater than 0.

In the reheating process, the adjustment of the operating setting can comprise: measuring the temperature of the supply air after flowing through the evaporator and reducing a target temperature for the temperature of the supply air after flowing through the evaporator.

The setting of the target temperature of the air after the evaporator is also referred to as variation of the setpoint of the air temperature after the evaporator. If the target temperature of the air to be reached after the evaporator is reduced, more strongly cooled air is provided, and the power consumption in the overall system of the cooling system is increased.

The reduction of the target temperature can be carried out until reaching a minimal target temperature, in particular this measure can be carried out repeatedly and/or step-by-step. The target temperature can be set here, for example, to a permissible value of at least 2 to 4° C. to prevent icing of the evaporator due to water condensing out of the evaporator supply air flow.

In the reheating process, the adjustment of the operating setting can alternatively or additionally comprise: setting the condition or quality of the supply air supplied to the evaporator, wherein the recirculated air component in the supply air is increased. If warmer supply air is supplied to the evaporator, which can be carried out by admixing already heated recirculated air from the vehicle interior, the evaporator has to provide a higher cooling power, which results in an increased power consumption in the overall system of the cooling system.

In the reheating process, the adjustment of the operating setting can alternatively or additionally comprise: incorporating at least one further component of the cooling system arranged fluidically in parallel or in series to the evaporator, in particular a chiller operating as a water heat pump evaporator and/or a rear evaporator for the climate control of a rear vehicle region. The chiller is typically used here to cool an electrical component of the vehicle, such as a battery. The rear evaporator can be provided in a vehicle, but can be deactivated, for example, due to the number of vehicle occupants, because the rear vehicle region (rear) is not supposed to be specially climate controlled. To increase the load consumption as a whole, such a rear evaporator can also be incorporated.

In the reheating process, the adjustment of the operating setting can alternatively or additionally comprise: increasing the amount of air which is guided through the heating register.

In the reheating process, the adjustment of the operating setting can alternatively or additionally comprise: reducing the supply air flow via the external heat exchanger.

By setting the quantity of supplied supply air at the heating register and/or at the external heat exchanger, the power consumption of the overall system of the cooling system can be influenced in a desired manner.

The above-mentioned adjustments of the operating setting are each used alone or in arbitrary combinations with one another to increase the power consumption of the overall system. In this way, the power to be dissipated at the external heat exchanger increases. In particular, the coolant is present as gaseous in a larger component at the entry of the external heat exchanger. This accordingly has the result that sufficient coolant is available at the evaporator, so that sufficient coolant is also present in the coolant accumulators provided on the system side.

Furthermore, a cooling system having heat pump function for a motor vehicle is proposed,

having a coolant compressor, which is connectable or connected to a primary line and a secondary line;

an external heat exchanger, which is arranged in the primary line;

an evaporator, which is arranged in the primary line;

a heating register, which is arranged in the secondary line;

at least one reheating expansion valve, which is arranged between the heating register and the external heat exchanger in the secondary line;

wherein the cooling system is configured to be operated using a reheating process according to any one of the preceding claims, and

wherein in such a reheating mode, the coolant flows through the following components of the cooling system in succession starting from the coolant compressor: heating register and reheating expansion valve in the secondary line, external heat exchanger and evaporator in the primary line.

The cooling system can comprise a chiller arranged fluidically in parallel to the evaporator and/or a rear evaporator arranged fluidically in parallel to the evaporator. However, these additional evaporators can also be arranged in a series circuit with respect to the main evaporator.

The cooling system can be embodied having at least one movable temperature valve, which is arranged before or after the heating register with respect to a supply air flow direction.

The cooling system can have at least one movable supply air valve, which is arranged before the evaporator with respect to a supply air flow direction.

The temperature valve(s) and/or the supply air valve(s) can be part of a climate-control device, in which the heat exchangers acting for the conditioning of the supply air flow to the cabin are accommodated.

A motor vehicle can be equipped with an above-described cooling system. The motor vehicle can in particular be an electric vehicle. In an electric vehicle, the efficient operation of the cooling system can result in power savings, so that a greater range of the electric vehicle can be achieved in this way. In particular, due to the above-described measures, the usage window of a reheating mode, in particular a heat pump reheat mode, can be enlarged, so that such a reheating mode can be used more often. A reduced average electrical power consumption results in this way, because typically an electrical auxiliary heater only has to be switched on much later or possibly even not at all.

### BRIEF DESCRIPTION OF THE FIGURES

Further advantages and details of the invention result from the following description of embodiments with reference to the figures. In the figures:

FIG. 1 shows a schematic and simplified circuit diagram of a cooling system for a motor vehicle;

FIG. 2 shows a simplified log(p)-h diagram to illustrate the circulation process in the reheating mode.

FIG. 3 shows a flow chart of an exemplary implementation of the reheating process, in particular by means of the cooling system described in FIG. 1.

### DETAILED DESCRIPTION

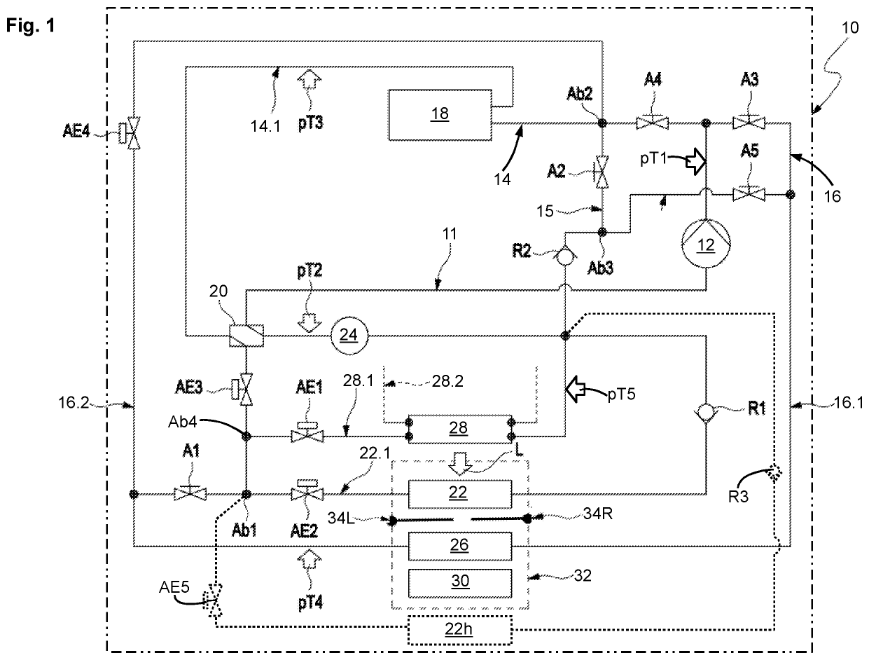

FIG. 1 shows an embodiment of a cooling system 10 for a motor vehicle schematically and in simplified form. The cooling system 10 comprises a coolant circuit 11, which can be operated both in a cooling system mode (also referred to as AC mode in short) and also in a heat pump mode. In the embodiment shown, the cooling system 10 comprises a coolant compressor 12, an external heat exchanger 18, an internal heat exchanger 20, an evaporator 22, and an accumulator or coolant collector 24. The external heat exchanger 18 can be designed as a condenser or gas cooler. In particular, the external heat exchanger 18 can have bidirectional flow through it in the embodiment shown.

The evaporator 22 is shown here by way of example as a front evaporator for a vehicle. The evaporator 22 is also representative of further evaporators possible in a vehicle, for example, rear evaporators, which can be arranged fluidically in parallel to one another. In other words, the cooling system 10 thus comprises at least one evaporator 22.

A shutoff valve A4 is arranged downstream of the compressor 12. An expansion valve AE2 is provided upstream of the evaporator 22.

In the context of this description, in the entire coolant circuit 11 of the cooling system 10, the section from the compressor 12 to the outer heat exchanger 18, to the inner heat exchanger 20, and to the evaporator 22 is referred to as the primary line 14.

The cooling system 10 furthermore comprises a heating register 26 (also referred to as a heating condenser or heating gas cooler). A shutoff valve A3 is arranged upstream of the heating register 26. A shutoff valve A1 is arranged downstream of the heating register 26. Furthermore, an expansion valve AE4 is arranged downstream of the heating condenser 26.

In the context of this description, in the entire coolant circuit of the cooling system 10, the section from the compressor 12 to the heating register 26, to the expansion valve AE4, and to a branch Ab2 is referred to as the secondary line 16. The secondary line 16 comprises a heating branch 16.1, which extends from the shutoff valve A3 via the heating register 26 to the shutoff valve A1. Furthermore, the secondary line 16 comprises a reheating branch or reheat branch 16.2, which is fluidically connectable upstream to the heating register 26 and downstream to the external heat exchanger 5. The secondary line 16 or the reheat branch 16.2 opens at a branching point Ab2 into the primary line 14.

The cooling system 10 comprises a further evaporator or chiller 28. The chiller 28 is provided fluidically in parallel to the evaporator 22. The chiller 28 can be used, for example, for cooling an electrical component of the vehicle, but also for implementing a water heat pump function utilizing the waste heat of at least one electrical component. An expansion valve AE1 is connected upstream before the chiller 28.

The cooling system 10 can also have an electrical heating element 30, which is embodied, for example, as a high-voltage PTC heating element. The electrical heating element 30 is used as an auxiliary heater for a supply air flow L guided into the vehicle interior. The electrical heating element 30 can be housed together with the heating register 26 and the evaporator 22 in an air conditioner 32. The electrical heating element 30 can be arranged connected downstream of the heating register 26.

Furthermore, check valves R1 and R2 are also visible in FIG. 1. Furthermore, several sensors pT1 to pT5 for detecting pressure and/or temperature of the coolant are also shown. It is to be noted that the number of the sensors and their arrangement are only shown by way of example here. A cooling system 10 can also have fewer or more sensors. In the example shown, combined pressure/temperature sensors pT1 to pT5 are shown as sensors. However, it is also conceivable that sensors separate from one another are used for measuring pressure or temperature and are possibly also arranged spatially separated from one another along the coolant lines.

The cooling system 10 can be operated in different modes, which are briefly described hereinafter.

In the AC mode of the coolant circuit 11, the coolant compressed to high pressure flows starting from the coolant compressor 12 with open shutoff valve A4 into the external heat exchanger 18. It flows from there to the high-pressure section of the internal heat exchanger 20 and the completely open expansion valve AE3. Via a branching point Ab1, the coolant can flow to the expansion valve AE2 and into the interior evaporator 22 (evaporator section 22.1). In parallel or alternatively, the coolant can flow via a branching point Ab4 and the expansion valve AE1 into the chiller 28 (chiller section 28.1). From the evaporator 22 and/or the chiller 28, the coolant flows on the low-pressure side into the collector 24 and through the low-pressure section of the interior heat exchanger 20 back to the compressor 12.

In the AC mode, the heating branch 16.1 or the secondary line 16 is shut off by means of the shutoff valve A3, so that hot coolant cannot flow through the heating register 26. To retrieve coolant from the inactive heating branch 16.1, the shutoff element A5 designed as a shutoff valve can be opened, so that the coolant can flow via the shutoff element A5 and the check valve R2, with shutoff element A2 closed at the same time, in the direction of the collector 24.

In the heating mode of the coolant circuit 11, the shutoff valve A4 is closed and the shutoff valve A3 is open, so that hot coolant can flow in the heating branch 16.1.

To carry out the heating function by means of the chiller 28 to implement a water heat pump mode, the coolant compressed by means of the coolant compressor 12 flows via the open shutoff valve A3 into the heating register 26. At the heating register 26, heat is emitted to a supply air flow L guided into the vehicle interior. The coolant subsequently flows via the open shutoff valve A1 and the branching point Ab1. It is expanded by means of the expansion valve AE1 in the chiller 28 to absorb waste heat of the electrical and/or electronic components arranged in a coolant circuit 28.2. In this heating function, the expansion valves AE3 and AE4 are closed, the shutoff valve A5 is closed, and the shutoff valve A2 is open. Coolant displaced in the water heat pump mode can be suctioned via the shutoff valve A2 from a bidirectional branch 14.1 or the primary line 14 and supplied via the check valve R2 to the collector 24.

To carry out the heating function by means of the external heat exchanger 18 as a heat pump evaporator, the coolant compressed by means of the coolant compressor 12 flows via the open shutoff valve A3 to emit heat to a supply air flow L into the heating register 26. Subsequently, it is expanded via the open shutoff valve A1 by means of the expansion valve AE3 in the external heat exchanger 18 to absorb heat from the ambient air. The coolant then flows via a heat pump recirculation branch 15 to the collector 24 and back to the coolant compressor 12. The expansion valves AE1, AE2, and AE4 remain closed in this case, as does the shutoff valve A5.

An indirect triangle circuit can be implemented in that with open shutoff valve A1, the coolant compressed by the coolant compressor 12 is expanded by means of the expansion valve AE1 in the chiller 28, wherein at the same time no mass flow is generated on the coolant side, thus in the coolant circuit 28.2, thus, for example, the fluid used as the coolant, such as water or water-glycol mixture, remains standing on the coolant side of the chiller 28 or coolant does not actively flow through the chiller 28. The expansion valves AE2, AE3, and AE4 remained closed in this switching variant.

In a reheating or reheat mode, the supply air flow L supplied into the vehicle interior is first cooled and thus dehumidified by means of the evaporator 22. Using the heat supplied to the coolant via the compressor 12, the supply air flow L can be completely or at least partially heated again by means of the heating register 26.

For this purpose, the cooling system 10, in particular the air conditioner 32, has temperature valves 34 which are settable, in particular controllable and pivotable, between the evaporator 22 and the heating register 26. In the illustrated example, a left and a right temperature valve 34L and 34R (schematically shown in FIG. 1) are arranged. The temperature valves 34L, 34R can be set or pivoted between an open position, which is referred to as the 100% position, and a closed position, which is referred to as the 0% position. Alternatively, it is also possible to connect the temperature valves 34R, 34L downstream from the heating register 26.

In the 100% position, the entire supply air flow L flowing through the evaporator 22 is guided via the heating register 26 and heated before it can flow into the passenger compartment of the vehicle. In the 0% position, the entire supply air flow L flowing through the evaporator 22 flows in the bypass around the heating register 26 without heating and thus without absorbing heat into the passenger compartment.

In an x position of the temperature valves 34L and 34R at 0%<x<100%, these temperature valves are only partially open, so that in each case only a partial air flow of the supply air flow L flowing through the evaporator 22 is guided via the heating register 26. This heated partial air flow can subsequently be admixed to the remaining cooled and dehumidified partial air flow. The supply air flow L heated in this way is supplied to the passenger compartment of the vehicle. For example, a 50% position indicates that the temperature valves 34R and 34L are only open halfway, thus 50%.

A rear evaporator 22h arranged fluidically in parallel to the evaporator 22 is an optional component in a cooling system 10. The rear evaporator 22h is used in particular to climate control a rear region (rear) of the motor vehicle. The rear evaporator 22h can be connected, for example, at the branching point Ab1. A separate expansion valve AE5 is assigned to the rear evaporator 22h, in particular arranged upstream of the rear evaporator 22h. A further check valve R3 can be arranged downstream of the rear evaporator 22h. Finally, the rear evaporator 22 is connected to the low-pressure supply line to the coolant collector downstream of the check valve R1.

A reheating or reheat mode of the coolant circuit 11 or the cooling system 10 is carried out in different ways as a function of the heat balance.

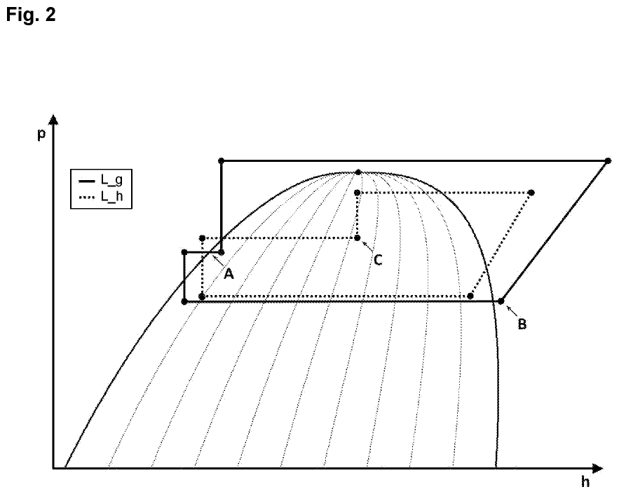

A possible operating method 500 for the reheating or reheat mode is explained by way of example hereinafter on the basis of the flow chart of FIG. 2 and with reference to the cooling system 10 and its components shown in FIG. 1. Such an operating method is typically implemented as a control program in a control unit for the cooling system or for the climate control in a vehicle.

A reheating mode is considered in which the coolant flows starting from the compressor 12 via the open shutoff valve A3 to the heating register 26 (heating condenser or heating gas cooler). The shutoff valve A1 is closed and the coolant flows via the expansion valve AE4 to the external heat exchanger 18. The coolant then passes the internal heat exchanger 20 on the high-pressure side and reaches the evaporator 22 via the open expansion valve AE3 and the expansion valve AE2. From there, the coolant reaches the compressor 12 again via the coolant collector 24 and the low-pressure section of the internal heat exchanger 20. In this reheating process, the temperature valves 34L, 34R can be moved into suitable positions which can assume a value of 0% (temperature valves 34L, 34R closed) to 100% (temperature valves 34L, 34R completely open).

FIG. 2 shows, in a schematic and simplified log (p)-h diagram, solely qualitatively the coolant circulation process and the effects linked to the reheating process presented here. The circulation process is run through counterclockwise.

The circulation process shown by solid line L_g illustrates the problem that in the event of small power excesses, the coolant in the external heat exchanger 18 is present nearly completely or predominantly in the two-phase physical state. This is indicated by the arrow A directed toward the isobar curve. Pressure is dissipated via the expansion valve AE2 and it is apparent from the circulation process shown by the solid line that a deficiency of coolant can result on the low-pressure side, which results in an overheated exit of coolant at the evaporator 22, which is illustrated by the point B. This can have an effect, for example, on the air-side temperature at the evaporator 22, so that the interior comfort in the vehicle is negatively influenced in this way. In other words, high temperature differences of the supply air result after the evaporator 22, which leads to comfort losses.

Furthermore, oil deposits can also occur in the coolant accumulator 24, depending on the design of the cooling system 10. Due to the absence or a strong reduction of a liquid phase of coolant in the coolant accumulator 24, oil can increasingly remain in the coolant accumulator 24 and is no longer supplied to the compressor 12, which can result in lubrication problems at the compressor 12.

If the power consumption of the cooling system 10 is increased, so that a greater or higher power excess results, which is illustrated in simplified form by the circulation process L_h shown by dashed lines, the power or heat to be dissipated at the external heat exchanger 18 also increases, so that the coolant is present in two phases in a significantly greater proportion or with an increasing proportion at its entry. This is illustrated in the circulation process shown by dashed lines at point C, which is quasi-shifted from left to right by the load increase. Accordingly, sufficient coolant is now available on the low-pressure side of the cooling system 10 for the evaporator 22 and/or the chiller 28 and/or a rear evaporator. Accordingly, a sufficient component of liquid coolant is also contained in the coolant accumulator 24, so that the above-described problem of the air-side temperature inhomogeneity and the inadequate lubrication of the compressor 12 does not occur.

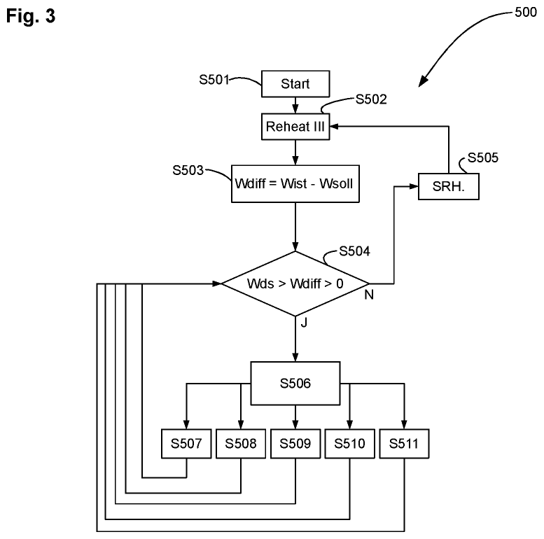

FIG. 3 shows in simplified form a reheating process 500, in which the cooling system 10 is set so that the coolant flow, as described above, flows from the compressor via the heating register 26, the expansion valve AE4, the external heat exchanger 18, the internal heat exchanger 20, the expansion valve AE3, at least the evaporator 22, and finally to the coolant accumulator 24.

According to the reheating process 500 shown in FIG. 3, in operation after the start (S501) of the cooling system 10 to a point in time not shown in greater detail here, a transition takes place to a reheating mode, which is designated here by reheat III (S502). A possible condition which has to be met to start the reheating mode (S502) can be, for example, the measured ambient temperature. The reheating process can be activated in particular when the ambient temperature is up to 15° C., in particular is approximately 5° C. to 15° C.

In such a reheating process 500, the following steps can be carried out for improved coolant management.

Firstly, in S503, a heat differential value Wdiff is determined by comparing a heat emission actual value Wist at the heating register 26 to a heat emission target value Wsoll, wherein Wdiff=Wist−Wsoll.

In S504 it is determined whether the heat differential value Wdiff determined in S503 is greater than zero (“0”) and less than a heat differential threshold value Wds. It is thus determined in this way whether a low heat or power excess exists.

In S506, at least one operating setting of the cooling system 10 is adjusted, so that the load consumption in the cooling system 10 is increased when the condition is met in S504. If the condition is not met in S504, i.e., either there is a power deficit or a high power excess, the reheating process branches in a step S505, which is representative for method steps SRH to be carried out under these conditions, which are not described in more detail here, however.

The adjustment of the operating setting can comprise step S507: measuring the temperature of the supply air after the flow through the evaporator 22 and reducing a target temperature SP T_Verd for the temperature of the supply air to the heating register after flowing through the evaporator 22. The reduction of the target temperature SP T_Verd can be carried out here until reaching a minimum permissible target temperature. This can in particular be repeated and/or carried out step-by-step.

The adjustment of the operating setting can comprise step S508: setting the condition or quality of the supply air (L) supplied to the evaporator 22, wherein the recirculated air component in the supply air is increased, presuming, of course, that its admixture causes the desired load increase at the evaporator due to an increase of the entropy in the supply air flow to the evaporator.

The adjustment of the operating step can comprise step S509: incorporating at least one further component of the cooling system 10, which is arranged fluidically in parallel or in special cases also in series to the evaporator 22, in particular the chiller 28 operating as a water heat pump evaporator and/or the rear evaporator 22h for the climate control of a rear vehicle region.

The adjustment of the operating setting can comprise step S510: increasing the amount of air which is guided through the heating register 22.

The adjustment of the operating setting can comprise step S511: reducing the supply air flow via the external heat exchanger 18. The external heat exchanger 18 can also be referred to as a cooling package having the integrated components condenser 18 or gas cooler 18. The reduction of the supply air flow can be carried out via closable and/or continuously adjustable cooling air entry and/or reduction of the fan activation, which results in a reduction of the amount of air suctioned in from the surroundings.

Steps S507 to S511 can be combined with one another individually or in combinations which are arbitrary per se, in order to achieve the desired result of an increased power consumption. If the desired result of the increased power excess is achieved by possibly executing one of steps S507 to S511 or a combination of several of these steps S507 to S511 multiple times, the condition in step S504 is no longer met, so that the reheating process 500 branches in step S505, which is representative of a state of the cooling system 10 in which the risk of a coolant deficiency, in particular in the liquid physical state, is not present on the low-pressure side or in the coolant accumulator 24, and the reheating process 500 in particular does not have to run through steps S507 to S511.

1-12. (canceled)

13. A reheating process for operating a cooling system having a heat pump function for a motor vehicle, wherein the cooling system comprises:
a coolant compressor, which is connectable or connected to a primary line and a secondary line;
an external heat exchanger, which is arranged in the primary line;
an evaporator, which is arranged in the primary line;
a heating register, which is arranged in the secondary line;
at least one reheating expansion valve, which is arranged between the heating register and the external heat exchanger in the secondary line;
wherein the reheating process comprises the following steps:
determining a heat differential value by comparing a heat emission actual value at the heating register to a heat emission target value,
adjusting at least one operating setting of the cooling system, so that the load capacity in the cooling system is increased if the heat differential value (Wdiff) is greater than 0 and less than a heat differential threshold value.

14. The reheating process of claim 13, wherein the adjusting of the operating setting comprises: measuring the temperature of the supply air after flowing through the evaporator and reducing a target temperature for the temperature of the supply air after flowing through the evaporator.

15. The reheating process of claim 14, wherein the reduction (S507) of the target temperature (SP T_Verd) is carried out until reaching a minimal target temperature, in particular is carried out repeatedly and/or step-by-step.

16. The reheating process of claim 13, wherein the adjusting of the operating setting comprises: setting the condition or quality of the supply air supplied to the evaporator, wherein the recirculated air component in the supply air is increased.

17. The reheating process of claim 13, wherein the adjusting of the operating setting comprises: incorporating at least one further component of the cooling system, which is arranged fluidically in parallel or in series to the evaporator, in particular a chiller operating as a water heat pump evaporator and/or a rear evaporator for the climate control of a rear vehicle region.

18. The reheating process of claim 13, wherein the adjusting of the operating setting comprises: increasing the amount of air which is guided through the heating register.

19. The reheating process of claim 13, wherein the adjusting of the operating setting comprises: reducing the supply air flow via the external heat exchanger.

20. A cooling system having a heat pump function for a motor vehicle, having
a coolant compressor, which is connectable or connected to a primary line and a secondary line;
an external heat exchanger, which is arranged in the primary line;
an evaporator, which is arranged in the primary line;
a heating register, which is arranged in the secondary line;
at least one reheating expansion valve, which is arranged between the heating register and the external heat exchanger in the secondary line;
wherein the cooling system is configured to be operated using a reheating process, and
wherein the coolant in such a reheating mode flows through the following components of the cooling system in succession starting from the coolant compressor:
heating register and reheating expansion valve in the secondary line, external heat exchanger and evaporator in the primary line.

21. The cooling system of claim 20, having a chiller arranged fluidically in parallel to the evaporator and/or a rear evaporator arranged fluidically in parallel to the evaporator.

22. The cooling system of claim 20, having at least one movable temperature valve, which is arranged before or after the heating register with respect to a supply air flow direction.

23. The cooling system of claim 20, having at least one movable supply air valve, which is arranged before the evaporator with respect to a supply air flow direction.

24. A motor vehicle having a cooling system, comprising:
a coolant compressor, which is connectable or connected to a primary line and a secondary line;
an external heat exchanger, which is arranged in the primary line;
an evaporator, which is arranged in the primary line;
a heating register, which is arranged in the secondary line;
at least one reheating expansion valve, which is arranged between the heating register and the external heat exchanger in the secondary line;
wherein the cooling system is configured to be operated using a reheating process, and
wherein the coolant in such a reheating mode flows through the following components of the cooling system in succession starting from the coolant compressor:
heating register and reheating expansion valve in the secondary line, external heat exchanger and evaporator in the primary line.

25. The reheating process of claim 14, wherein the adjusting of the operating setting comprises: setting the condition or quality of the supply air supplied to the evaporator, wherein the recirculated air component in the supply air is increased.

26. The reheating process of claim 15, wherein the adjusting of the operating setting comprises: setting the condition or quality of the supply air supplied to the evaporator, wherein the recirculated air component in the supply air is increased.

27. The reheating process of claim 14, wherein the adjusting of the operating setting comprises: incorporating at least one further component of the cooling system, which is arranged fluidically in parallel or in series to the evaporator, in particular a chiller operating as a water heat pump evaporator and/or a rear evaporator for the climate control of a rear vehicle region.

28. The reheating process of claim 15, wherein the adjusting of the operating setting comprises: incorporating at least one further component of the cooling system, which is arranged fluidically in parallel or in series to the evaporator, in particular a chiller operating as a water heat pump evaporator and/or a rear evaporator for the climate control of a rear vehicle region.

29. The reheating process of claim 16, wherein the adjusting of the operating setting comprises: incorporating at least one further component of the cooling system, which is arranged fluidically in parallel or in series to the evaporator, in particular a chiller operating as a water heat pump evaporator and/or a rear evaporator for the climate control of a rear vehicle region.

30. The reheating process of claim 14, wherein the adjusting of the operating setting comprises: increasing the amount of air which is guided through the heating register.

31. The reheating process of claim 15, wherein the adjusting of the operating setting comprises: increasing the amount of air which is guided through the heating register.

32. The reheating process of claim 16, wherein the adjusting of the operating setting comprises: increasing the amount of air which is guided through the heating register.
